(19) United States
(12) Patent Application Publication
(10) Pub. No.: US 2012/0317410 A1
(43) Pub. Date: Dec. 13, 2012

(54) PROTECTING DATA FROM DATA LEAKAGE OR MISUSE WHILE SUPPORTING MULTIPLE CHANNELS AND PHYSICAL INTERFACES

(75) Inventor: Keith L. Paulsen, Centerville, UT (US)

(73) Assignee: CIRQUE CORPORATION, Salt Lake City, UT (US)

(21) Appl. No.: 13/491,962

(22) Filed: Jun. 8, 2012

Related U.S. Application Data
(60) Provisional application No. 61/494,597, filed on Jun. 8, 2011.

(51) Int. Cl. H04L 9/28

(52) U.S. Cl. 713/153

(57) ABSTRACT

A system and method for two devices that communicate via a network, wherein at least one of the devices is a touch sensitive device, the two devices storing a common cryptographic key that enables all communications via the network to be encrypted.

### CROSS REFERENCE TO RELATED APPLICATIONS

This document claims priority to and incorporates by reference all of the subject matter included in the provisional patent application docket number 4982.CIRQ.PR, having Ser. No. 61/494,597, filed Jun. 8, 2011.

### BACKGROUND OF THE INVENTION

1. Field Of the Invention

This invention relates generally to touchpad technology. More specifically, touch information collected by the touchpad is protected from unintended data leakage or misuse while supporting multiple channels and physical interfaces.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

With this understanding of one capacitance sensitive touchpad, it is now possible to discuss the present invention and a particular application because of shortcomings in state of the art designs.

A problem that has arisen in point-of-sale (POS) devices is that they are vulnerable to tampering. The stealing of credit card information is on the rise and is a substantial cause of concern among consumers. Accordingly, there is a substantial benefit from making devices more secure that read confidential data from credit and debit cards that can be used to access accounts.

For example, there are many electronic devices that are used to read data stored on credit or debit cards. Most of these devices read information from a magnetic strip. However, other electronic devices read information from newer smart cards using radio frequency signals. Both of these types of electronic devices then enable a user to input a secret Personal Identification Number (PIN) in order to complete a transaction. The PIN is typically entered on a PIN Entry Device (PED). Vulnerabilities in the design of PEDs show that these vulnerabilities can be exploited using unsophisticated techniques to expose PINs, credit and debit card numbers and other cardholder data.

One method of obtaining PIN information is to detect PIN data as it is being entered from a keypad on the PED. CIRQUE® has already developed and described intrusion detection technology for protecting the enclosure or the cage around the touch and data entry technology. This technology is used to provide a PED that would be able to detect the presence of a foreign object, such as a sensor designed to detect input without interfering with the process of providing input to the PED, wherein the input is typically confidential information.

It is well known in the prior art that a touchpad must function in multiple roles. These roles include but should not be considered limited to functioning as a standard mouse during system initialization so that the touchpad is able to respond to commands to support additional simultaneous functions such as MICROSOFT® Intellimouse™.

It is also common to support multiple simultaneous channels such as in pass-through support for touchpad and touch stick data, buttons, and gestures such as pinch and zoom. Advanced multi-touch functions are often simultaneously supported using similar channelizing protocols.

Advances in touch technology created the need for multiple physical interfaces to support new system software and applications while preserving basic functionality common to older systems including basic pointer functions for BIOS during system boot and configuration. An example is supporting the PS/2 interface for pointer information and I2C or USB interfaces for multi-touch or signature capture information.

New requirements for human input devices include greater security such as protecting user input of personal information via simulated keyboard, simulated keypad, as well as protecting pointer information. New federal regulations for confidentiality are also driving input devices to support encryption of all human input data in some applications.

Because existing methods of securing data are able to output encrypted text (“crypt” hereinafter) and plain text representations of input data, they provide a means for an attacker to gather side channel information in one mode (the “plain text” mode) and use it against the device while in the other mode (the “crypt” mode).

One of the dangers of the type of attack that can be performed when a device uses plain text and crypt text is where an attacker highjacks the display and presents a malicious request for information and receives information from an unsuspecting user in plain text.

Another danger is where an attacker is able to interact with the input device, such as through sending it commands that provide the ability for the device to be removed from its environment where it can be remotely attacked, and then returned to its original environment.

Furthermore, it is possible to inject information into a system and perform man-in-the-middle attacks by inserting a bug device between the input device and the application CPU. A man-in-the-middle attack is a form of active eavesdropping in which the attacker makes independent connections with victims and relays messages between them, making them believe that they are talking directly to each other over a private connection, when in fact the entire conversation is controlled by the attacker. The attacker must be able to intercept all messages going between the two victims and inject new ones, which is straightforward in many circumstances.

To describe the present invention, it is necessary to provide a few definitions of terms. Beginning with a touch sensing device, such device can be a touch screen or touchpad. Thus a touch sensing device may be a sensor comprised of a plurality of electrodes supported by a substrate such as PCB material, glass, plastic, etc., and constructed to detect the location of a finger or other pointing object on or near a supporting substrate placed alone or behind an overlay or in front of a display device consisting of either back lighted or dynamic images such as on a CRT or LCD display, or placed behind movable keys, etc.

The touch sensitive device as an input device includes the ability to queue touches, simulated button presses and gestures, and then process commands such as enable, disable and set configuration information including programmable zone information and methods of collecting simulated button presses such as touch or lift-off and the number of and amount of information to collect. Configuration information includes but is not limited to output block format selection such as mouse, Intellimouse™, relative and absolute data format including simulated buttons, keyboard keys including control/shift/alt, encrypted passwords, PIN Block, or other formats. For the purposes of this invention the configuration information shall also include secure associations.

The next definition is for a Secure Cryptographic Device (SCD) which is defined herein as a device that provides physically and logically protected cryptographic services and storage. The SCD may be integrated into a larger system such as a terminal, cellphone, fuel pump, kiosk, Automated Teller Machine, point of sale (POS) device, pin entry device (PED), or other system. The system may be publicly accessible or not.

Finally, a tamper-resistant security module (TRSM) is defined herein as a device that incorporates physical protections to prevent compromise of cryptographic security parameters contained therein. Usually the protection is in the form of complex integrated wire meshes, epoxy potting material, interlock switches and brittle materials that make intrusion without detection very difficult without breaking the device. These physical countermeasures are often very expensive and of moderate utility.

It is noted that this method and device is related to U.S. Pat. No. 6,262,717 currently assigned to CIRQUE® Corporation and which claims programmable input zones including relative and absolute positioning zones, keyboard and keypad zones, scrolling zones, Glide Extend zones, Enter/Select zones, etc. Touch inputs are collected, queued and processed later within the touchpad such as drag, glide extend, button tap, double tap, gestures, and simulated buttons, digits, characters, Enter/Select, with special processing associated with the programmable input zones.

### BRIEF SUMMARY OF THE INVENTION

The present invention may be a system and method for two devices that communicate via a network, wherein at least one of the devices is a touch sensitive device, the two devices storing a common cryptographic key that enables all communications via the network to be encrypted.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

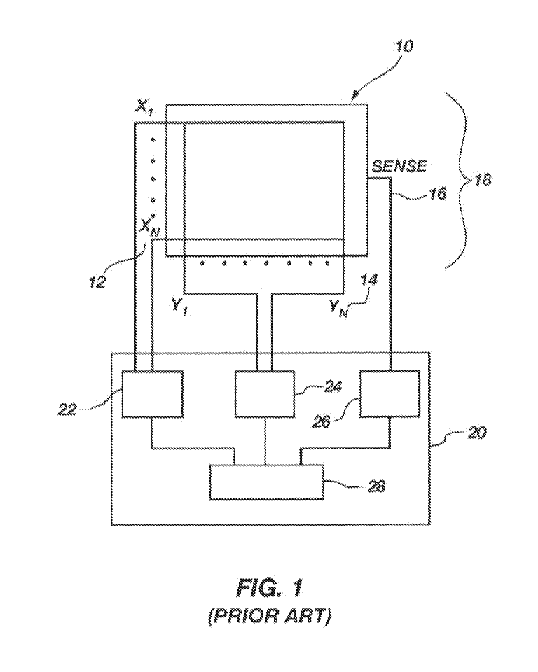

FIG. 2 is a block diagram illustrating how devices having matching keys can securely send encrypted data over non-secure networks.

FIG. 3 is a table showing data regarding Secure Associations that may be utilized by the present invention.

FIG. 4 is a block diagram illustrating how devices that cannot transmit data securely can use touchpads that have the same encryption key to securely send encrypted data over non-secure networks.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow. It should also be understood that the terms “touchpad”, “touchscreen”, “touch sensitive device”, “touch sensing device” and “touch input device” may be used interchangeably throughout this document.

One aspect of the invention may be described as a more robust transmission method between a touchpad and one or more receiving devices. Instead of using a combination of crypt (encrypted) and plain text, all information that is received by and transmitted from the touchpad is now encrypted, or is crypt text. This information includes all commands to the touchpad and all blocks of data received from it. By encrypting all data to and from the touchpad, even data that has nothing to do with security such as receiving a user's PIN, all observable data to and from the touchpad can be intercepted and not used to perform any attacks as described herein. Attacks become much more difficult because none of the observable data include a side channel that can be used to determine how the data is being transmitted to and from the touchpad. The observable data is now useless outside of a receiving device and the transmitting touchpad.

By encrypting all data to and from the touchpad, this method also prevents corrupted data from being acted upon by the touchpad or a receiving device because the corrupted data will not include information that shows that the data is valid. Thus, an attacker may not be able to inject fraudulent information into the conversation between the touchpad and a receiving device. Thus, an attacker is not able to maliciously prompt for a password or PIN input to try and coerce the touchpad into outputting plain text information as in the prior art.

The method of encrypting all data to and from the touchpad therefore may be categorized as continuously protecting user input and control information from unintended data leakage, as well as protecting data from becoming maliciously manipulated or unintentionally corrupted.

This method of continuous encryption may be useful in applications such as for entering passwords, PINs, secure messages, Cryptographic Keys, or other confidential information, as well as for general use in systems that must conform to new security requirements for financial transactions using publicly accessible devices.

By continuously performing encryption of the control commands and blocks of input data, the method described herein makes all observable data useless outside of the intended originating and receiving devices. The touchpad can be either device. It also prevents corrupted data from being acted upon including preventing an attacker from being able to inject fraudulent information into the system. The attacker is not able to maliciously prompt for a password or PIN input and coerce the touchpad into outputting plain text information as in the prior art.

This method may describe using secure associations to provide support for multiple secure channels and external interfaces including encryption in both directions between the touchpad and another device or application.

The intended receiving devices and applications may include such as devices and applications as system BIOS, operating systems, and applications running on a personal computer's CPU, cell phone's CPU, terminal's CPU, or a remote processor may be directly or indirectly connected to individual touchpad algorithms using multiple channels and external busses and be separated by other non-secure devices or such as across personal or local area networks.

In a first embodiment, Secure Associations (SA) are defined herein as devices that have been pre-programmed to have the cryptographic information needed for secure and encrypted communication between them. In other words, the devices that are going to communicate using the system and method of the present invention may have been pre-programmed with information that enables continuous encrypted communication.

The Secure Associations may include tables or other data structures for storing the information needed for continuous encrypted information. Such information may include source and destination device addresses, source and destination channel addresses, cryptographic key identifying information (KIF), channels, external bus, and a message authentication code.

This information may be transmitted along with the actual data that is being transmitted between devices for routing and cryptographic purposes. The cryptographic key identifying information may also be implied rather than explicitly transmitted. In a first embodiment, the destination address, cryptographic key, channel, external bus and key identifying information may be determined by lookup in the security associations table stored in each device's SCD.

The system and method of the present invention may always be encrypting data and control or command signals. The invention may also perform data integrity checks to prevent man-in-the-middle or other attacks where data that is not being transmitted between secure devices is injected into the system. By checking data integrity, corrupted or injected data can be found.

The present invention may also use routing data that supports remote tokenization of account numbers, may support button presses that are queued and encrypted as a packet as in standard PIN Block, may support using Secure Associations to create multiple encryption channels instead of external buses, may support different encryption methods that are based on touch zones to allow efficient coordinate data, may support X9.24 DUKPT for PIN Block processing w/o attracting attention, may support the sending of SMID or KIF, may support multiple external communication buses, may support sending encrypted absolute and relative coordinate data, and may support multiple destination devices for local processing and PIN processing at remote HSM.

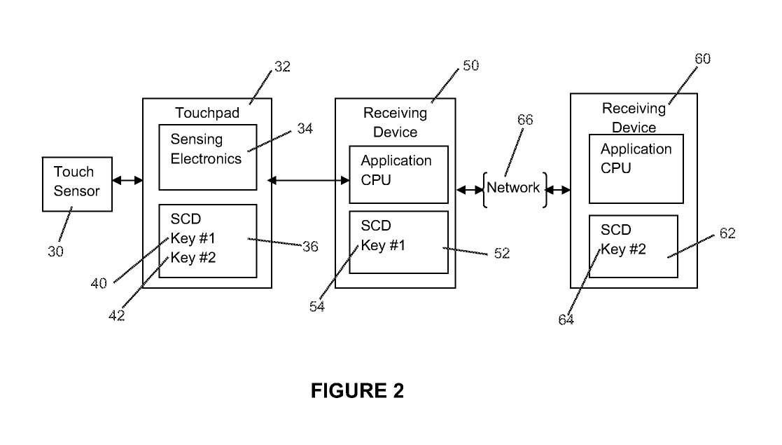

FIG. 2 is a block diagram that is provided to illustrate some principles of the present invention. A touch sensor 30 is shown being coupled to a touchpad 32. The touch sensor 30 includes the electrodes that collect touch and proximity information of objects that are detectable by the touchpad technology. This information is received by the touchpad 32 that includes the sensing electronics 34 for interpreting the data from the touch sensor 30. The touchpad 32 also includes a Secure Cryptographic Device 36 that is storing the information necessary for encrypted communication to devices outside the touchpad.

In this example, the Secure Cryptographic Device 34 is storing two different Keys 40, 42 or key identifying information that enables the touchpad 32 to exchange encrypted information with two different corresponding devices that are also pre-programmed with the same Keys. The touchpad 32 may store a Key for each of the devices with which it communicates.

As an illustration of one example, the touchpad 32 is shown as being able to communicate with two receiving devices 50, 60. There may be more or fewer devices. The touchpad 32 may be physically located at a same location as a receiving device, such as receiving device 50, or remotely connected via a network 66. The first receiving device 50 is shown as having a Secure Cryptographic Device 52 for storing its own cryptographic information. This cryptographic information includes a Key 54 that is the same as the Key 40 of the touchpad 32. Because each of the devices 32, 50 has the same Key 40, 54, the devices may continuously communicate only with encrypted communication. In other words, no non-encrypted data is ever sent from one device to the other. Without any plain text being transmitted, it may be impossible for an attacker to perform any attacks such as man-in-the- middle.

FIG. 2 also shows a second receiving device 60. The second receiving device 60 is shown as having a Secure Cryptographic Device 62 for storing its own cryptographic information. This cryptographic information includes a Key 64 that is the same as the Key 42 of the touchpad 32. Because each of the devices 32, 60 has the same Key 40, 64, the devices may continuously communicate only with encrypted communication.

The first and second receiving devices 50, 60 may not only be receiving devices, but may also transmit data to the touchpad 32 or to other devices. These devices 50, 60 may be financial institutions, Automated Teller Machines (ATMs), or any device that may benefit from secure and encrypted communication with a touchpad.

The use of cryptographic keys is a secure process wherein they are typically not transmitted over a network, but may be physically carried to a physical location to be installed. This physical delivery and installation of cryptographic keys may be the only way to ensure secure delivery.

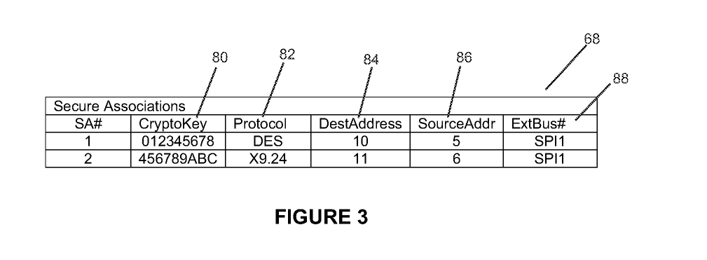

FIG. 3 is a table 68 that illustrates the type of information that can be stored for Secure Associations. This table should be considered an example only, and not limiting the invention. This table 68 may illustrate the Secure Associations of the touchpad 32 from FIG. 2.

Assuming that the touchpad 32 is capable of performing secure communications with two different devices, the devices are listed as Secure Associations 1 and 2. These devices may be physically local or remote. The data may include the cryptographic key 80 or key identifying information. Another field may define the encryption protocol 82 that should be used when communication with a particular device. Other useful fields may include a Destination Address 84 according to the network over which the data is transmitted, a Source Address 86, and the particular External Bus 88 that should be used for transmitting the encrypted data. Other data fields may also be included in the Secure Associations table, including a message authentication code (MAC), random touchpad data, or any other useful information needed for encryption, for transmitting the data from one device to another, or any other information that is desired.

The encryption protocols that may be used to encrypt the data that is transferred between devices may include, but should not be considered as limited to, Rabbit, X9.24, AES, etc.

The Secure Associations table 68 shown in FIG. 3 may be stored in a Secure Cryptographic Device. In that way, the data can be intercepted but not used against the user of the touchpad 32 or the device that is communicating with the touchpad. Without the Keys that are securely stored in the Secure Cryptographic Device of each device, the intercepted information may be useless.

Some aspects of the invention that may distinguish it from the prior art may include that the method may require that touchpad data is not sent one packet at a time, the method may not depend on a special PIN data entry command and timeout but may instead use a canceling operation, the method may not require a separate non-encrypted external bus but may instead operate on channels on multiple busses, the method may not toggle between encrypted and non-encrypted mode because Secure Associations may be concurrent and continuous, the method may not have a separate protected data entry screen area because all areas of the touchscreen are protected, and the method may not have open mode and secure mode zones because it may be routed.

Another advantage is that the embodiment may create a data stream to thereby provide a very fast transmission rate as compared to other transmission methods.

An embodiment of the invention may operate by providing protected keys at each end of the transmission so that it is irrelevant if the data being transmitted is intercepted from either device.

In a final embodiment of the invention, any of the devices that are capable of encryption and that are located between other devices that are not capable of encryption, the encrypting devices can be used to securely transmit data from a first location to a second location.

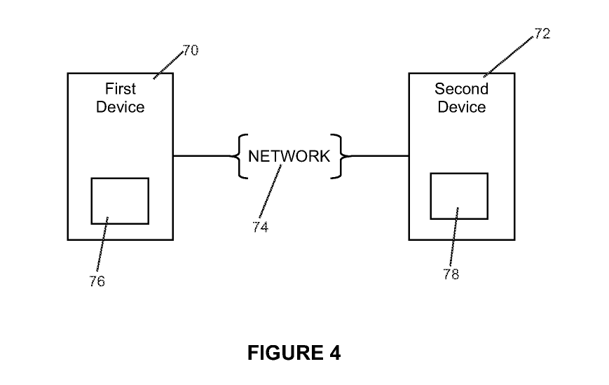

FIG. 4 is provided to illustrate the concept above. A first device 70 desires to transmit data securely to a second device 72 over a non-secure network 74. The first device 70 may include a touchpad 76 or other touch sensitive device. Likewise, the second device 72 may also include a touchpad 78. If the first device 70 and the second device 72 are secure, then the touchpads 76, 78 may receive data to be transmitted between the devices 70, 72. The touchpads 76, 78 may encrypt the data and transmit the encrypted data over the non-secure network 74. The encrypted data may be intercepted but the data will be secure as long as the touchpads 76, 78 have the same Key to use for encrypting the data. The data that can be transmitted is any data that can be transmitted over a network.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for securely transmitting data between devices, wherein the data can be intercepted, said method comprising:
1) providing a first device having a Secure Cryptographic Device for storing data used for encryption and transmission;
2) providing a second device having a Secure Cryptographic Device for storing data used for encryption and transmission;
3) providing a network for communication between the first device and the second device;
4) creating Secure Associations between the first device and the second device by storing at least a same encryption key in the Secure Cryptographic Device of the first device and the second device;
5) encrypting data to be transmitted from the first device to the second device using data from the Secure Associations; and
6) transmitting the encrypted data from the first device to the second device using the network.

2. The method as defined in claim 1 wherein the method further comprises decrypting the encrypted data in the second device using the same encryption key stored in the Secure Associations that are stored in the Secure Cryptographic Device of the second device.

3. The method as defined in claim 1 wherein the method further comprises providing a touch sensitive device as the first device.

4. The method as defined in claim 1 wherein the method further comprises using a non-secure network as the network for transmitting data between the first device and the second device.

5. The method as defined in claim 1 wherein the method further comprises selecting information for storage in the Secured Associations that is selected from the encryption and transmission information comprising a source address, a destination address, a cryptographic key, an encryption protocol, an external bus, a message authentication code and random touchpad data.

6. The method as defined in claim 1 wherein the method further comprises providing a third device that is securely coupled to the first device and a fourth device that is securely coupled to the second device, and wherein the third device communicates securely to the fourth device by sending unencrypted data to the first device, encrypting the data in the first device, transmitting the encrypted data to the second device, unencrypting the encrypted data in the second device, and transmitting the data from the second device to the fourth device.

7. The method as defined in claim 1 wherein the method further comprises selecting the second device from the group of devices comprising a terminal, cellphone, fuel pump, kiosk, Automated Teller Machine, point of sale (POS) device, pin entry device (PED), touch sensitive device, or other system.

8. The method as defined in claim 1 wherein the method further comprises only transmitting data that is characterized as encrypted between the first device and the second device so as to not require a secure network for transmission of the encrypted data.

9. The method as defined in claim 1 wherein the method further comprises performing a data integrity check on the encrypted data to prevent the use of corrupted data.

10. The method as defined in claim 1 wherein the method further comprises performing a data integrity check on the encrypted data to prevent the use of injected data that was not transmitted between the first device and the second device.

11. The method as defined in claim 1 wherein the method further comprises never transmitting data between the first device and the second device that is characterized as plain text.

12. The method as defined in claim 1 wherein the method further comprises using an implied cryptographic key identifying information.

13. The method as defined in claim 1 wherein the method further comprises transmitting the encrypted data as a group of packets and not as individual packets.

14. A system for securely transmitting data between devices, wherein the data can be intercepted, said method comprising:
a first device having a Secure Cryptographic Device for storing data used for encryption and transmission;
a second device having a Secure Cryptographic Device for storing data used for encryption and transmission;
a network for communication between the first device and the second device; and
a same encryption key stored as Secure Associations in the Secure Cryptographic Device of the first device and the second device.

15. The system as defined in claim 14 wherein the system further comprises a touch sensitive device as the first device.

16. The system as defined in claim 14 wherein the system further comprises a non-secure network as the network for transmitting data between the first device and the second device.

17. The system as defined in claim 14 wherein the system further comprises a Secured Associations table that is selected from the encryption and transmission information comprising a source address, a destination address, a cryptographic key, an encryption protocol, an external bus, a message authentication code and random touchpad data.

18. The system as defined in claim 14 wherein the system further comprises a third device that is securely coupled to the first device and a fourth device that is securely coupled to the second device, and wherein the third device communicates securely to the fourth device by sending unencrypted data to the first device, encrypting the data in the first device, transmitting the encrypted data to the second device, unencrypting the encrypted data in the second device, and transmitting the data from the second device to the fourth device.

19. The system as defined in claim 1 wherein the system further comprises selecting the second device from the group of devices comprising a terminal, cellphone, fuel pump, kiosk, Automated Teller Machine, point of sale (POS) device, pin entry device (PED), touch sensitive device, or other system.
